(19) United States
(12) Patent Application Publication
(10) Pub. No.: US 2015/0021906 A1
(43) Pub. Date: Jan. 22, 2015

(54) Pipe Fitting Assembly

(71) Applicant: David John PICTON, Auckland (NZ)

(72) Inventor: David John PICTON, Auckland (NZ)

(21) Appl. No.: 14/332,459

(22) Filed: Jul. 16, 2014

(30) Foreign Application Priority Data
Jul. 16, 2013 (NZ) 613260

(51) Int. Cl. F16L 33/207

(52) U.S. Cl. CPC F16L 33/2071
USPC 285/256

(57) ABSTRACT

A pipe fitting assembly for use with pipes made of plastics materials. The pipe fitting assembly has a body which includes at least one male pipe engagement section which includes a plurality of engagement ridges. The pipe fitting assembly also includes swage collar over the or each male pipe engagement section which is secured at one end to the body and is swageable over its associated male pipe engagement section to hold a pipe securely to the pipe fitting assembly. The or each male pipe engagement section also includes at least one pipe engagement detection feature which is configured to allow relatively free movement of a pipe onto the or each male pipe engagement section, but is configured to resist movement of a pipe back off the or each male pipe engagement section.

### FIELD OF THE INVENTION

This invention relates to a pipe fitting assembly, and in particular, but not exclusively to a pipe fitting assembly for joining pipes made of plastics materials.

### BACKGROUND

For some time it has been common to use plastic water pipes for general plumbing use in the building industry. Typically PVC or Polybutylene pipes are used.

For quick and reliable joints, fittings have been designed for use with these plastic pipes. The fittings generally fit inside the plastic pipe, and the plastic pipe is squeezed onto ridges on the exterior of the fitting to produce a water tight and robust joint.

The squeeze is generally produced by an aluminium sleeve which is secured at one end to the fitting, and which is swaged over the pipe to squeeze the pipe onto the fitting. The swaging is carried out using a purpose-made swaging tool.

In the most part this produces a water tight and reliable joint. However, experience has shown that some installers do not push the plastic pipe far enough onto the fitting before swaging the aluminium retaining collar. And if the pipe is not fully home before it is swaged the joint may leak and it will be weaker, and in some cases it will fail.

Also, there is a chance that the plastic pipe will inadvertently slip back, away from proper engagement with the fitting, just prior to the swaging operation. This can happen when the installer releases his hand grip on the pipe to pick up the swaging tool. As with the situation where the plastic pipe is not pushed fully home on the fitting, the resultant joint, when the pipe has slipped back a little, will be weaker and may leak or fail.

And since the joints are often embedded within the walls and structure of a building, a failed joint can be inconvenient and costly to repair. In addition, a failed joint in a mains water system, within a building structure, can cause damage, particularly if the leak is not detected for some time.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### OBJECT

It is therefore an object of the present invention to provide a pipe fitting assembly which will at least go some way towards overcoming one or more of the above mentioned problems, or at least provide the public with a useful choice.

### STATEMENTS OF THE INVENTION

Accordingly, in a first aspect, the invention may broadly be said to consist in a pipe fitting assembly having a body which includes at least one male pipe engagement section which includes a plurality of engagement ridges, and the pipe fitting assembly also having a swage collar associated with the or each male pipe engagement section, the or each swage collar being secured at one end to the body and being swageable over its associated male pipe engagement section to hold a pipe securely to the pipe fitting assembly, wherein the or each male pipe engagement section also includes at least one pipe engagement detection feature which is configured to allow relatively free movement of a pipe onto the or each male pipe engagement section and to resist movement of a pipe back off the or each male pipe engagement section.

Preferably the or each pipe engagement detection feature includes one or more barb shaped features configured to allow relatively free movement of a pipe onto the or each male pipe engagement section and to resist movement of a pipe back off the or each male pipe engagement section.

Preferably the or each barb shaped feature is in the form of a detection ridge extending around the circumference of the or each male pipe engagement section.

Preferably the or each detection ridge has two faces, a first face which faces a free end of its associated male pipe engagement section, a second face which faces away from the free end of its associated male pipe engagement section, and each face rising to a crest of the detection ridge.

Preferably the or each first face is a sloping face which rises at a shallow angle of less than thirty five degrees to the longitudinal axis of its associated male pipe engagement section.

Preferably the or each second face is a sloping face which rises at a steep angle of more than seventy degrees to the longitudinal axis of its associated male pipe engagement section.

Preferably at least an outer part of the or each second face is in the form of a flat face which is substantially perpendicular to the longitudinal axis of its associated male pipe engagement section.

Optionally the or each second face comprises an undercut face.

Optionally the crest of the or each detection ridge overhangs at least a part of its associated second face.

Optionally the or each pipe engagement detection feature is in the form of a barb shaped protrusion.

Preferably the or each male pipe engagement section also includes an end stop configured to positively stop movement of a pipe onto the or each male pipe engagement section.

Preferably the or each pipe engagement detection feature is situated adjacent its associated end stop.

Preferably the or each swage collar is swaged at one end to secure the or each swage collar to the body.

In a second aspect, the invention may broadly be said to consist in a plumbing system incorporating at least one pipe fitting assembly substantially as specified herein.

Preferably the plumbing system also includes the use of pipework made of plastics materials.

In a third aspect, the invention may broadly be said to consist in a method of assembling a plumbing system including the steps of;
fitting a pipe onto a pipe fitting assembly substantially as specified herein,
attempting to pull the pipe back off the pipe fitting assembly and manually checking the level of resistance encountered,
depending on the level of resistance encountered, making a decision as to whether or not the pipe has been pushed far enough onto the pipe fitting assembly.

The invention may also broadly be said to consist in the parts, elements and features referred to or indicated in the specification of the application, individually or collectively, and any or all combinations of any two or more of the parts, elements or features, and where specific integers are mentioned herein which have known equivalents, such equivalents are incorporated herein as if they were individually set forth.

### DESCRIPTION

Further aspects of the present invention will become apparent from the following description which is given by way of example only and with reference to the accompanying drawings in which:

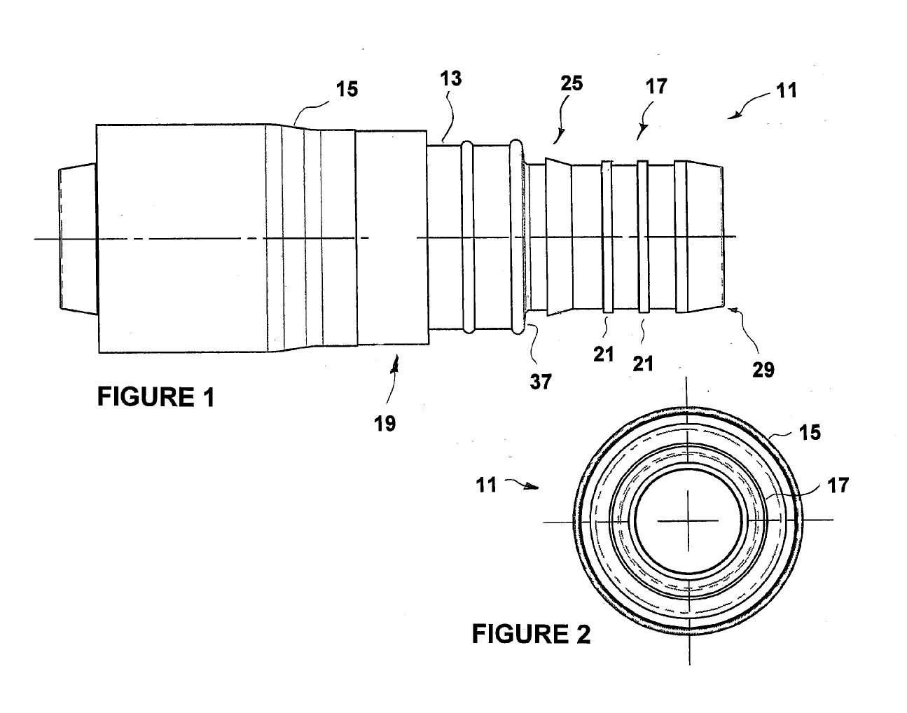

FIG. 1 is a side elevation view of a pipe fitting assembly, shown with one of the swage collars removed to allow details of a body section of the fitting assembly to be seen,

FIG. 2 is an end elevation view of the pipe fitting assembly shown in FIG. 1, and

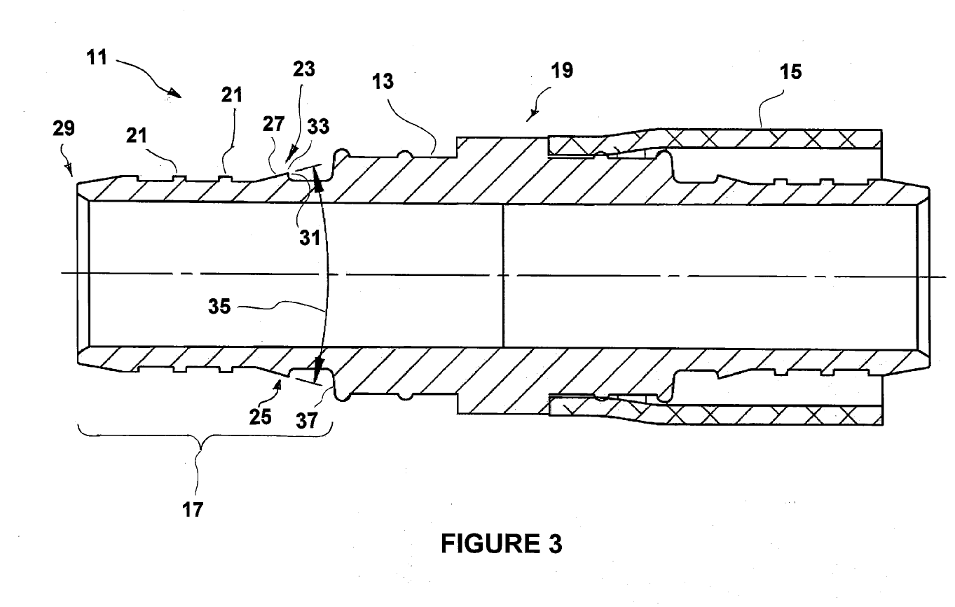

FIG. 3 is a cross sectional view of the pipe fitting assembly shown in FIG. 1, again with one of the swage collars removed.

With reference to FIGS. 1 to 3, a pipe fitting assembly (11) will now be described. The pipe fitting assembly (11) has a body (13) and two swage collars (15). Note: in the figures only one swage collar (15) is shown. In FIG. 1 the right hand collar has been removed, and in FIG. 3 the left hand collar has been removed; in both cases to allow the body (13) to be shown in greater detail.

The pipe fitting assembly (11) in this example is a connector fitting which includes two male pipe engagement sections (17) situated each side of a central body section (19). Other examples of the pipe fitting assembly could be “Tee” fittings or reducer fittings.

Pipe fitting assemblies of this type are used in household and commercial property plumbing systems and are used to join sections of plastic piping, for example sections of polybutylene pipes. The pipe fitting assemblies (11) themselves are typically made of nylon or acetal or glass filled acetal plastics materials, and the swage collars (15) are typically made of aluminium. In this example, the pipe fitting assembly (11) is made from a “Nylon 12” plastics material having a Shore Hardness of D 75.

The pipe fitting assembly (11) has a swage collar (15) associated with each male pipe engagement section (17). Each swage collar (15) is secured at one end to the body (13). The free end of each swage collar (15) is swageable over its associated male pipe engagement section (17) to hold a pipe securely to the pipe fitting assembly (11). Each of the male pipe engagement sections (17) include two engagement ridges or ribs (21).

The swage collars are swaged at one end to secure them to the body (13). When the other end of the collars (15) are swaged over a plastic pipe that is pushed onto the pipe fitting assembly (11), the plastic material of the pipe is squeezed onto and about the two engagement ribs (21) to hold the pipe securely and to prevent leaks.

A unique feature of the pipe fitting assembly (11) according to the present invention is that each male pipe engagement section (17) also includes a pipe engagement detection feature (23).

The pipe engagement detection features (23) are configured to allow relatively free movement of a pipe onto each male pipe engagement section (17) and to resist movement of the pipe back off each male pipe engagement section (17).

Each pipe engagement detection feature (23) includes a ‘barb’ shaped feature, which in this example takes the form of a detection ridge (25) which extends around the circumference of each male pipe engagement section (17).

It can be seen that each detection ridge (25) has two faces, a first face (27) which faces a free end (29) of its associated male pipe engagement section (17), and a second face (31) which faces away from the free end (29). Both the first face (27) and the second face (31) rise to a crest (33) of the detection ridge (25).

The first face (27) is a sloping face which rises at a shallow angle of about fifteen degrees to the longitudinal axis of the male pipe engagement section (17). The first face (27) is therefore a part of a truncated conical shape, where the conical angle (35) is approximately thirty degrees.

In FIG. 3 it can be seen that at least the outer part of the second face (31) is in the form of a flat face which rises from a radiused base part of the second face (31). The flat portion of the second face (31) rises at a steep angle of about ninety degrees to the longitudinal axis of the male pipe engagement section (17).

Each male pipe engagement section (17) also includes an end stop (37) which is configured to positively stop movement of a pipe onto the fitting (11). And, each pipe engagement detection feature (23) is situated adjacent its associated end stop (37). For this reason, the pipe engagement detection feature (23) is ideally situated to help detect whether a pipe has been pushed far enough onto the pipe fitting assembly (11) prior to swaging of the swage collars (15).

The pipe fitting assembly (11) according to the present invention allows a method of assembling a plumbing system which includes the following steps;
fitting a pipe onto a pipe fitting assembly (11) as described above,
attempting to pull the pipe back off the pipe fitting assembly and manually checking the level of resistance encountered, and
depending on the level of resistance encountered, making a decision as to whether or not the pipe has been pushed far enough onto the pipe fitting assembly (11).

If the plumber or fitter has pushed a pipe onto the pipe fitting assembly (11) he or she can then check the amount of force required to pull the pipe back off the pipe fitting assembly. With the accumulation of experience it will soon become apparent whether the pipe has only been pushed a short way onto the pipe fitting assembly (11), perhaps over only one of the engagement ribs (21); or fully home and over the pipe engagement detection feature (23) as well. If the pipe has been pushed over the pipe engagement detection feature (23) it will be appreciably more difficult to pull the pipe back off the pipe fitting assembly (11), since the pipe engagement detection feature (23) will tend to snag the pipe and make it more difficult to remove.

These steps allow a plumber or fitter to positively confirm that a pipe has been sufficiently pushed onto the pipe fitting assembly (11) prior to swaging the collar (15), thus providing improved assurance that the joint will not leak or fail.

In addition, the pipe engagement detection feature (23) helps to prevent the pipe from inadvertently slipping off the engagement ribs (21), just before the swaging operation. When the fitter releases his grip on the pipe or the pipe fitting assembly (11), to pick up the swaging tool, it is possible that the pipe can slip a little, just before swaging, and cause a poor joint that may leak or fail. But if the pipe has been pushed fully home until it has engaged with the pipe engagement detection feature (23), that engagement will help to prevent the inadvertent slip-back, and therefore the chance of a poor joint after swaging is further reduced.

### VARIATIONS

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

In the example shown and described above the first face (27) is a sloping face which rises at a shallow angle of about fifteen degrees, however it is envisaged that the first face (27) could rise at a range of angles, but preferably at an angle that is less than thirty five degrees to the longitudinal axis of its associated male pipe engagement section.

Similarly, the second face (31) is a substantially perpendicular face which rises at a steep angle of about ninety degrees to the longitudinal axis of its associated male pipe engagement section. It is envisaged that in an alternative configuration the second face (31) could be an undercut sloping face, or a face which rises at a range of angles, but preferably at an angle that is at more than seventy degrees to the longitudinal axis of its associated male pipe engagement section. In such a variation, the crest of the ridge (33) could overhang the second face (31) giving the ridge a barbed shape when viewed in cross section

In the above example, at least the outer part of the second face (31) is in the form of a flat face which rises from a radiused base. In an alternative configuration the entire second face (31) could comprise a concave shaped face.

In the example shown and described above the pipe engagement detection feature (23) is in the form of a raised ridge having a substantially perpendicular back face, however in an alternative configuration the pipe engagement detection feature could take the form of one or more barb shaped protrusions.

### DEFINITIONS

Throughout this specification the word “comprise” and variations of that word, such as “comprises” and “comprising”, are not intended to exclude other additives, components, integers or steps.

### ADVANTAGES

Thus it can be seen that at least the preferred form of the invention provides a pipe fitting assembly which includes a pipe engagement detection feature and which allows a plumber or fitter to positively confirm that a pipe has been sufficiently pushed onto the pipe fitting assembly (11) prior to swaging the collar (15).

In addition, the pipe engagement detection feature minimises the chance that the pipe will inadvertently slip back away from proper engagement just before the collar is swaged.

As noted above, it is important that the pipe is fully engaged with the pipe fitting at the time that the collar is swaged, to ensure that a leak-proof and robust joint is produced.

For these reasons, it can be seen the incorporation of the pipe engagement detection feature significantly reduces the chance that a poor joint will be formed, thereby reducing the chance of a subsequent leak or pipe-work failure.

1-16. (canceled)

17. A pipe fitting assembly having a body which includes at least one male pipe engagement section which includes a plurality of engagement ridges, and the pipe fitting assembly also having a swage collar associated with the or each male pipe engagement section, the or each swage collar being secured at one end to the body and being swageable over its associated male pipe engagement section to hold a pipe securely to the pipe fitting assembly, wherein the or each male pipe engagement section also includes at least one pipe engagement detection feature which is configured to allow relatively free movement of a pipe onto the or each male pipe engagement section and to resist movement of a pipe back off the or each male pipe engagement section.

18. A pipe fitting as claimed in claim 17, wherein the or each pipe engagement detection feature includes one or more barb shaped features configured to allow relatively free movement of a pipe onto the or each male pipe engagement section and to resist movement of a pipe back off the or each male pipe engagement section.

19. A pipe fitting as claimed in claim 18, wherein the or each barb shaped feature is in the form of a detection ridge extending around the circumference of the or each male pipe engagement section.

20. A pipe fitting as claimed in claim 19, wherein the or each detection ridge has two faces, a first face which faces a free end of its associated male pipe engagement section, a second face which faces away from the free end of its associated male pipe engagement section, and each face rises to a crest of the detection ridge.

21. A pipe fitting as claimed in claim 20, wherein the or each first face is a sloping face which rises at a shallow angle of less than thirty five degrees to the longitudinal axis of its associated male pipe engagement section.

22. A pipe fitting as claimed in claim 20, wherein the or each second face is a sloping face which rises at a steep angle of more than seventy degrees to the longitudinal axis of its associated male pipe engagement section.

23. A pipe fitting as claimed in claim 20, wherein at least an outer part of the or each second face is in the form of a flat face which is substantially perpendicular to the longitudinal axis of its associated male pipe engagement section.

24. A pipe fitting as claimed in claim 20, wherein the or each second face comprises an undercut face.

25. A pipe fitting as claimed in claim 20, wherein the crest of the or each detection ridge overhangs at least a part of its associated second face.

26. A pipe fitting as claimed in claim 17, wherein the or each pipe engagement detection feature is in the form of a barb shaped protrusion.

27. A pipe fitting as claimed in claim 17, wherein the or each male pipe engagement section also includes an end stop configured to positively stop movement of a pipe onto the or each male pipe engagement section.

28. A pipe fitting as claimed in claim 27, wherein the or each pipe engagement detection feature is situated adjacent its associated end stop.

29. A pipe fitting as claimed in claim 17, wherein the or each swage collar is swaged at one end to secure the or each swage collar to the body.

30. A plumbing system incorporating at least one pipe fitting assembly substantially as claimed herein.

31. A plumbing system as claimed in claim 30, wherein the plumbing system also includes the use of pipe-work made of plastics materials.

32. A method of assembling a plumbing system comprising;
fitting a pipe onto a pipe fitting assembly substantially as claimed herein;
attempting to pull the pipe back off the pipe fitting assembly and manually checking the level of resistance encountered; and
depending on the level of resistance encountered, making a decision as to whether or not the pipe has been pushed far enough onto the pipe fitting assembly.
